(19) United States
(12) Patent Application Publication
(10) Pub. No.: US 2016/0132571 A1
(43) Pub. Date: May 12, 2016

(54) Method and Apparatus for Presenting Spatial-Temporal Data

(71) Applicant: Huawei Technologies Co., Ltd., Shenzhen (CN)

(72) Inventors: Bing Ni, HongKong (HK); Mingxuan Yuan, HongKong (HK); Shiming Zhang, Shenzhen (CN)

(21) Appl. No.: 14/987,986

(22) Filed: Jan. 5, 2016

Related U.S. Application Data
(63) Continuation of application No. PCT/CN2014/088544, filed on Oct. 14, 2014.

(30) Foreign Application Priority Data
Feb. 13, 2014 (CN) 201410050963.2

(51) Int. Cl. G06F 17/30; G06T 11/20; G06F 3/0481

(52) U.S. Cl. CPC G06F 17/30554; G06F 3/04812; G06T 11/206; G06F 17/30958; G06F 17/30477

(57) ABSTRACT

A method and apparatus for presenting spatial-temporal data, which relate to the field of information processing technologies, are presented. When querying data according to a user query request, the apparatus for presenting spatial-temporal data finds various types of data that correspond to a spatial condition and that are included in the data that the user query request requests to query, where the various types of data include regional data and variation data of a preset feature, and presents, in a graph, both the regional data and the variation data of the preset feature. In this way, various types of data are found during data query, so that spatial-temporal data is presented in a centralized way in a specific manner, and spatial-temporal data dynamics may be further presented and hence a user intuitively views an association relationship between spatial data and temporal data, which facilitates further analysis of the data.

### CROSS-REFERENCE TO RELATED APPLICATIONS

This application is a continuation of International Application No. PCT/CN2014/088544, filed on Oct. 14, 2014, which claims priority to Chinese Patent Application No. 201410050963.2, filed on Feb. 13, 2014, both of which are hereby incorporated by reference in their entireties.

### TECHNICAL FIELD

The present disclosure relates to the field of information processing technologies, and in particular, to a method and an apparatus for presenting spatial-temporal data.

### BACKGROUND

With improvement of wireless communications technologies and with popularization of intelligent terminal devices, various intelligent services emerge in a wireless network, where spatial-temporal data included in the various intelligent services not only has spatial-temporal information but also has description of user behavior. A spatial-temporal trajectory and spatial-temporal behavior of a single user are random, but there is a very large amount of information in spatial-temporal trajectories and spatial-temporal behavior in the scale of mass data. Based on this, researchers may analyze and study group-based spatial-temporal behavior, for example, may perform mass horizontal comparison to discover an anomaly. The researchers cannot analyze massive volumes of data by relying on a conventional manner of single statistics, and selection of a suitable visualization method greatly facilitates study and analysis. How to present these spatial-temporal data in a centralized way using a visualization method is a relatively important issue.

### SUMMARY

Embodiments of the present disclosure provide a method and an apparatus for presenting spatial-temporal data, which implement centralized presentation of spatial-temporal data.

A first aspect of the embodiments of the present disclosure provides a method for presenting spatial-temporal data, including receiving a user query request, where the user query request includes a spatial condition. Acquiring spatial-temporal data that the user query request, requests to query, where the spatial-temporal data includes regional data corresponding to the spatial condition, and variation data of a preset feature of a region corresponding to the spatial condition, and presenting a graph of the acquired spatial-temporal data, so that the graph presents the regional data and the variation data of the preset feature.

In a first possible implementation manner of the first aspect of the embodiments of the present disclosure, the graph includes a closed boundary. The variation data includes variation moments and status information of the preset feature at the variation moments, and the presenting a graph of the acquired spatial-temporal data, so that the graph presents the regional data and the variation data of the preset feature further includes presenting, inside the boundary, the regional data, presenting, on the boundary, the variation moments in the variation data and presenting, outside the boundary at the variation moments, status information of the preset feature of the region corresponding to the spatial condition.

With reference to the first possible implementation manner of the first aspect of the embodiments of the present disclosure, in a second possible implementation manner of the first aspect of the embodiments of the present disclosure, the presenting, outside the boundary at the variation moments, status information of the preset feature of the region corresponding to the spatial condition further includes representing the status information using a linear or column bar extending to the outside from the boundary. The length of the linear or column bar is used to indicate a weighted value of status information of the preset feature of locations in the region that corresponds to the spatial condition, or a calculated value of the weighted value.

With reference to the first or second possible implementation manner of the first aspect of the embodiments of the present disclosure, in a third possible implementation manner of the first aspect of the embodiments of the present disclosure, the presenting, outside the boundary at the variation moments, status information of the preset feature of the region corresponding to the spatial condition further includes, sequentially presenting, outside the boundary, the corresponding status information at the variation moments. The presenting, on the boundary, the variation moments in the variation data further includes, presenting, on the boundary at a variation moment corresponding to an acquiring start time of the spatial-temporal data, a first cursor, and sequentially sliding a second cursor to the variation moments on the boundary, where the first cursor and the second cursor respectively represent the acquiring start time and an acquiring end time of the spatial-temporal data.

With reference to the third possible implementation manner of the first aspect of the embodiments of the present disclosure, in a fourth possible implementation manner of the first aspect of the embodiments of the present disclosure, the method further includes receiving, from the graph, an operation request of a user for the first cursor or the second cursor. If it is requested to slide the first cursor or the second cursor to a variation moment, sliding the first cursor or the second cursor to the variation moment along the boundary, and presenting, outside the boundary at the variation moment, corresponding status information.

A second aspect of the embodiments of the present disclosure provides an apparatus for presenting spatial-temporal data, including a query request unit configured to receive a user query request, where the user query request includes a spatial condition, a data acquiring unit configured to acquire spatial-temporal data that the user query request requests to query and that is received by the query request unit, where the spatial-temporal data includes regional data corresponding to the spatial condition, and variation data of a preset feature of a region corresponding to the spatial condition, and a presentation unit configured to present a graph of the spatial-temporal data acquired by the data acquiring unit, so that the graph presents the regional data and the variation data of the preset feature.

In a first possible implementation manner of the second aspect of the embodiments of the present disclosure, the graph includes a closed boundary, and the presentation unit further includes a region presentation subunit configured to present, inside the boundary, the regional data, a moment presentation subunit configured to present, on the boundary, the variation moments in the variation data, and a status presentation subunit configured to present, outside the boundary at the variation moments, status information of the preset feature of the region corresponding to the spatial condition.

With reference to the first possible implementation manner of the second aspect of the embodiments of the present disclosure, in a second possible implementation manner of the second aspect of the embodiments of the present disclosure, the status presentation subunit is further configured to represent the status information using a linear or column bar extending to the outside from the boundary, where the length of the linear or column bar is used to indicate a weighted value of status information of the preset feature of locations in the region that corresponds to the spatial condition, or a calculated value of the weighted value.

With reference to the first or second possible implementation manner of the second aspect of the embodiments of the present disclosure, in a third possible implementation manner of the second aspect of the embodiments of the present disclosure, the status presentation subunit is further configured to sequentially present, outside the boundary, the corresponding status information at the variation moments, and the moment presentation subunit is further configured to present, on the boundary at a variation moment corresponding to an acquiring start time of the spatial-temporal data, a first cursor, and sequentially slide a second cursor to the variation moments on the boundary, where the first cursor and the second cursor respectively represent the acquiring start time and an acquiring end time of the spatial-temporal data.

With reference to the third possible implementation manner of the second aspect of the embodiments of the present disclosure, in a fourth possible implementation manner of the second aspect of the embodiments of the present disclosure, the apparatus further includes an operation request unit configured to receive, from the graph, an operation request of a user for the first cursor or the second cursor, and if it is requested to slide the first cursor or the second cursor to a variation moment, slide the first cursor or the second cursor to the variation moment along the boundary, and present, outside the boundary at the variation moment, corresponding status information.

As can be seen, in the embodiments of the present disclosure, when querying data according to a user query request, the apparatus for presenting spatial-temporal data finds various types of data that correspond to a spatial condition and that are included in the data that the user query request requests to query. The various types of data include regional data and variation data of a preset feature, and presents, in a graph, both the regional data and the variation data of the preset feature. In this way, various types of data are found during data query, so that spatial-temporal data is presented in a centralized way in a specific manner, and spatial-temporal data dynamics may be further presented. Therefore, a user intuitively views an association relationship between spatial data and temporal data, which facilitates further analysis of the data.

### BRIEF DESCRIPTION OF DRAWINGS

To describe the technical solutions in the embodiments of the present disclosure more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a flowchart of a method for presenting spatial-temporal data according to an embodiment of the present disclosure;

FIG. 2 is a flowchart of another method for presenting spatial-temporal data according to an embodiment of the present disclosure;

FIG. 3A, FIG. 3B, FIG. 3C and FIG. 3D are schematic diagrams of graphs of spatial-temporal data that are presented in actual application examples according to an embodiment of the present disclosure;

FIG. 4 is a schematic structural diagram of an apparatus for presenting spatial-temporal data according to an embodiment of the present disclosure;

FIG. 5 is a schematic structural diagram of another apparatus for presenting spatial-temporal data according to an embodiment of the present disclosure; and

FIG. 6 is a schematic structural diagram of another apparatus for presenting spatial-temporal data according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

In the specification, claims, and accompanying drawings of the present disclosure, the terms “first”, “second”, “third”, “fourth”, and so on (if existent) are intended to distinguish between similar objects but do not necessarily indicate a specific order or sequence. It should be understood that the data termed in such a way are interchangeable in proper circumstances so that the embodiments of the present disclosure described herein can be implemented in orders except the order illustrated or described herein. Moreover, the terms “include”, “contain” and any other variants mean to cover the non-exclusive inclusion, for example, a process, method, system, product, or device that includes a list of steps or units is not necessarily limited to those units, but may include other units not expressly listed or inherent to such a process, method, system, product, or device.

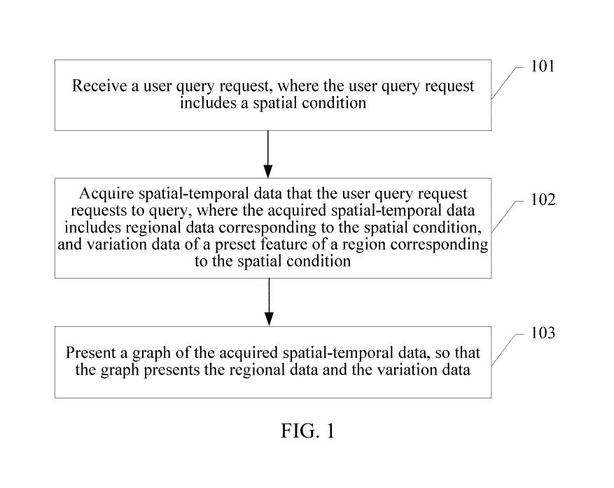

An embodiment of the present disclosure provides a method for presenting spatial-temporal data, which mainly presents spatial-temporal data dynamics. The method in this embodiment may be performed in any medium or in any query medium and may be applied to any spatial-temporal data. The method in this embodiment is a method performed by an apparatus for presenting spatial-temporal data, where the apparatus may be a terminal device for a user to query spatial data, or the like. A flowchart is shown in FIG. 1, including:

Step 101: Receive a user query request, where the user query request includes a spatial condition.

It may be understood that, the apparatus for presenting spatial-temporal data stores various types of spatial-temporal data, for example, spatial-temporal data such as earthquake indices of multiple areas, densities of population of multiple areas, and estate prices of multiple areas. The spatial-temporal data may include temporal information, spatial information, and variation data of a preset feature, and the like. These spatial-temporal data may be preset by a user in the apparatus for presenting spatial-temporal data, and the stored variation data may be constantly updated as the feature varies.

The apparatus for presenting spatial-temporal data may provide a data query interface to the user, and in this way, the user may initiate a query of spatial-temporal data using the interface. Furthermore, the user may enter information about regions that need to be queried, that is, the foregoing spatial condition. In this way, the apparatus for presenting spatial-temporal data receives a user query request including the spatial condition, where the user query request may further include information about features that need to be queried and that are of a region corresponding to the spatial condition. Further, the user may further enter information of a time period that needs to be queried, that is, a time condition. In this way, the apparatus for presenting spatial-temporal data may present only information within this time period, and does not present information of all time periods, which can reduce a data presentation time.

Step 102: Acquire spatial-temporal data that the user query request requests to query, where the acquired spatial-temporal data includes regional data corresponding to the spatial condition, and variation data of a preset feature of a region corresponding to the spatial condition.

Furthermore, variation moments of the preset feature, and status information of the feature at the variation moments may be included, for example, variation data of estate prices of a place within a year. Furthermore, the preset feature may be an earthquake index, a density of population, an estate price, or the like.

Step 103: Present a graph of the acquired spatial-temporal data, so that the graph presents the regional data and the variation data of the preset feature of the region corresponding to the spatial condition.

Various types of data acquired in step 102 needs to be shown in the graph in a centralized way, so that the user intuitively views all the data that are found, according to the foregoing user query request, by the apparatus for presenting spatial-temporal data.

As can be seen, in the embodiments of the present disclosure, when querying data according to a user query request, the apparatus for presenting spatial-temporal data finds various types of data that correspond to a spatial condition and that are included in the data that the user query request requests to query. The various types of data include regional data and variation data of a preset feature, and presents, in a graph, both the regional data and the variation data of the preset feature. In this way, various types of data are found during data query, so that spatial-temporal data is presented in a centralized way in a specific manner, and spatial-temporal data dynamics may be further presented. Therefore, a user intuitively views an association relationship between spatial data and temporal data, which facilitates further analysis of the data.

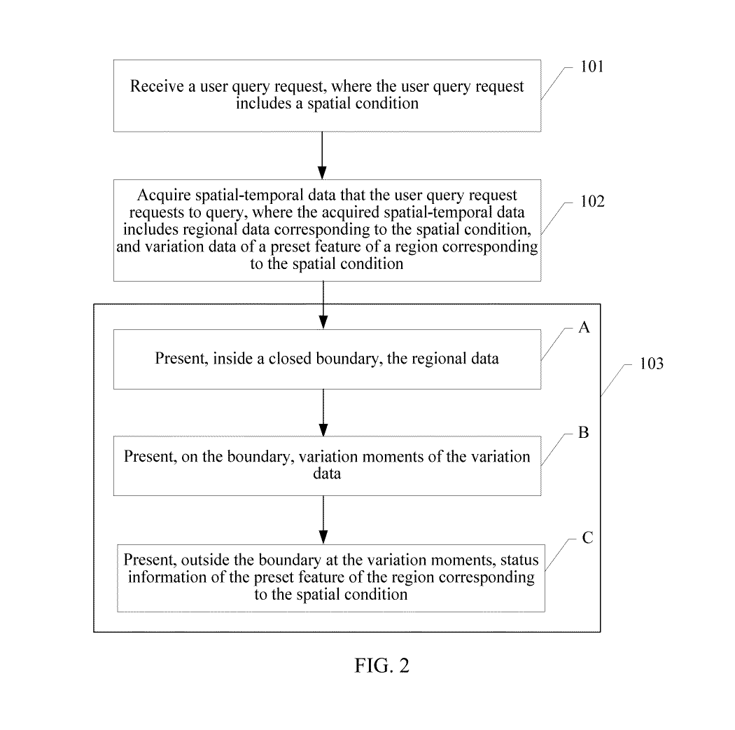

Referring to FIG. 2, in a specific embodiment, the graph finally presented by the apparatus for presenting spatial-temporal data may include a closed boundary. The variation data acquired in step 102 includes the variation moments of the feature, and the status information of this feature at the variation moments. When the apparatus for presenting spatial-temporal data performs step 103, step 103 may be further implemented using the following steps:

A: Present, inside the closed boundary (for example, a circle), the regional data acquired in step 102. Furthermore, when the regional data is presented, the regional data may be presented inside the boundary using a two-dimensional picture or a three-dimensional picture. The size of the closed boundary may represent a range of the queried region.

B: Present, on the boundary, the variation moments in the variation data, where an interval between two variation moments depends on time granularity at which an entire time domain is divided. For example, the closed boundary may represent a year, and twelve points on the boundary may be used to represent twelve variation moments, and separately represent twelve months, where an interval between two variation moments is one month.

C: Present, outside the boundary at the variation moments, status information of the preset feature of the region corresponding to the spatial condition. For example, a sum of densities of population of an area within a month, which may be further represented using a linear or column bar extending to the outside from the boundary, where a length of the linear or column bar may indicate a weighted value of status information of the feature of specific locations in the region that corresponds to the spatial condition, or another calculated value obtained using the weighted value. The status information may be represented using another shape (for example, a cone) extending to the outside from the boundary, as long as the status information at the variation moments may be distinguished.

As can be seen, by means of step A to step C above, the various types of data acquired in step 102 may be all presented in a centralized way in a manner of the closed boundary. It should be noted that, step A to step C are not subject to an absolute sequential relationship, and may be performed at the same time, or may be sequentially performed, and FIG. 2 shows only a specific implementation manner.

Further, in another specific embodiment, when the apparatus for presenting spatial-temporal data performs step B, two sliding cursors may be used on the boundary to respectively represent an acquiring start time and an acquiring end time of the foregoing spatial-temporal data, and these two cursors may be presented in different forms, for example, in different colors or in different shapes, or the like. When step C is performed, the spatial-temporal data may be further presented in the following two manners.

(1) Status information of variation moments within this time period from the acquiring start time to the acquiring end time is presented once and for all in the graph.

(2) According to step 102 above, which is, acquire the spatial-temporal data, the status information at the variation moments is sequentially presented. Furthermore, the corresponding status information may be presented outside the boundary at a variation moment that corresponds to the acquiring start time. Then, when status information corresponding to a next variation moment is acquired in step 102, the corresponding status information is presented at the next variation moment of the variation moment that corresponds to the acquiring start time. In this way, step 102 and step C are performed cyclically, until the status information of all the variation moments is acquired and is presented in the graph. That is, the apparatus for presenting spatial-temporal data sequentially presents, outside the foregoing closed boundary, the corresponding status information at the variation moments.

In this case, step B and step C also need to be cooperatively completed. Furthermore, a first cursor is first presented on the foregoing closed boundary at the variation moment that corresponds to the acquiring start time, where the first cursor is used to represent the acquiring start time of the spatial-temporal data. As the corresponding status information at the variation moments is sequentially presented in step C, a second cursor sequentially slides to the variation moments on the closed boundary, where the second cursor is used to represent the acquiring end time of the spatial-temporal data. During this process, the foregoing first cursor may not slide after being determined, and the second cursor slides on the closed boundary as spatial-temporal data is acquired. For example, if status information A corresponding to a variation moment a, is acquired in step 102, the apparatus for presenting spatial-temporal data presents, on the boundary at the variation moment a, the second cursor, and presents, outside the boundary, the status information A. If status information B corresponding to a next variation moment b is further acquired in step 102, the second cursor slides to the variation moment b along the boundary, and the status information B is presented outside the boundary.

In another specific embodiment, because the foregoing second cursor may slide on the boundary, the user may drag, in the graph presented by the apparatus for presenting spatial-temporal data, the first cursor or the second cursor, to view status information of any variation moment. The apparatus for presenting spatial-temporal data not only may perform step 101 to step 103, but also may perform the following steps: when an operation request of the user for the first cursor or the second cursor is received from the graph, if it is requested to slide the first cursor or the second cursor to a variation moment, the apparatus for presenting spatial-temporal data slides the first cursor or the second cursor to the variation moment along the boundary, and presents, outside the boundary at the variation moment, corresponding status information. The first cursor and the second cursor do not represent a sequential relationship, and instead indicate different cursors.

The graph in this embodiment presents various types of data in a centralized way are described using the following several specific examples, where the closed boundary in the graph is described using a circle as an example:

(1) Presentation of a Variation of Earthquake Indices

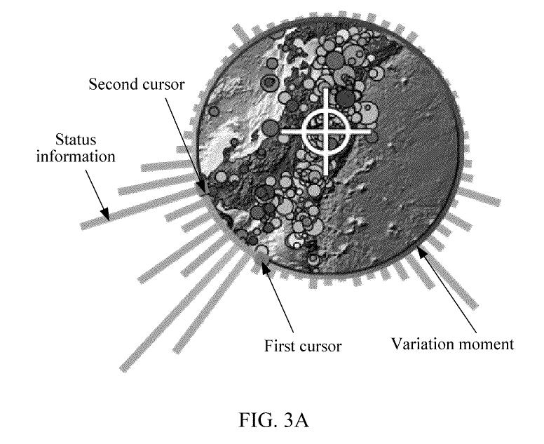

Referring to FIG. 3A, regional data that corresponds to a spatial condition and that is included in a user query request is presented inside a disk. There are multiple variation moments on the disk (the closed boundary), a start moment of an earthquake is at the top end of the disk, and then, a variation moment of the earthquake begins to increase in a clockwise direction, where a moment when the earthquake has progressed halfway is at the bottom of the disk, and the entire disk presents a process of the earthquake. Column bars with different lengths are distributed outside the disk at the variation moments of indices of the earthquake, where a length of the column bar represents a weighted value of an earthquake index, of specific locations in a region at a variation moment, presented inside the disk. As can be seen, as the process of the earthquake progresses, a sum of the earthquake indices in the region exponentially increases.

There are two slideable cursors on the disk, where the two cursors can be dragged to view an earthquake index at a corresponding variation moment.

(2) Presentation of a Variation of Densities of Population

As shown in FIG. 3B, regional data that corresponds to a spatial condition and that is included in a user query request is presented inside a disk. There are multiple variation moments on the disk (the closed boundary), zero o'clock at noon is at the top end of the disk, and then a variation moment begins to increase in a clockwise direction, where twelve o'clock at noon is at the bottom of the disk, and the entire disk presents densities of population in this region within twenty-four hours, where an interval between two adjacent variation moments is one hour. Column bars with different lengths are distributed outside the disk at the variation moments of the densities of population, where a length of the column bar represents a weighted value of densities of population, of specific locations in the region, presented inside the disk within one hour.

There are two slideable cursors on the disk, and the two cursors can be dragged to view a sum of densities of population of variation moments within a time period.

(3) Presentation of a Variation of Paths Used by Most People

As shown in FIG. 3C, distribution of most frequently used paths is presented inside a disk. There are multiple variation moments on the disk (the closed boundary), December is at the top end of the disk, and then, a variation moment begins to increase in a clockwise direction, where the entire disk presents a density of population of the most frequently used path within twelve months of a year, and an interval between two adjacent variation moments is one month. Column bars with different lengths are distributed outside the disk at the variation moments of the most frequently used path, where a length of the column bar represents a weighted value of a most frequently used path presented inside the disk within a month and a quantity of people using the most frequently used path.

There are two slideable cursors on the disk, and the two cursors can be dragged to view a variation of paths used by most people at variation moments within a time period.

(4) Presentation of a Variation of Estate Prices

As shown in FIG. 3D, user query requests are presented inside a disk. There are multiple variation moments on the disk (the closed boundary), a start year (for example, 1980) is at the top of the disk, and then, a variation moment begins to increase in a clockwise direction, where the entire disk presents estate prices of this region of a time period from the start year to a current year, and an interval between two adjacent variation moments is one year. Column bars with different lengths are distributed outside the disk at the variation moments of the estate prices, where a length of the column bar represents a mean value of estate prices of specific locations in the region presented inside the disk within a year, and the mean value is a ratio of a weighted value of the estate prices of the specific locations to a quantity of the specific locations.

There are two slideable cursors on the disk, and the two cursors can be dragged to view estate prices of variation moments within a time period.

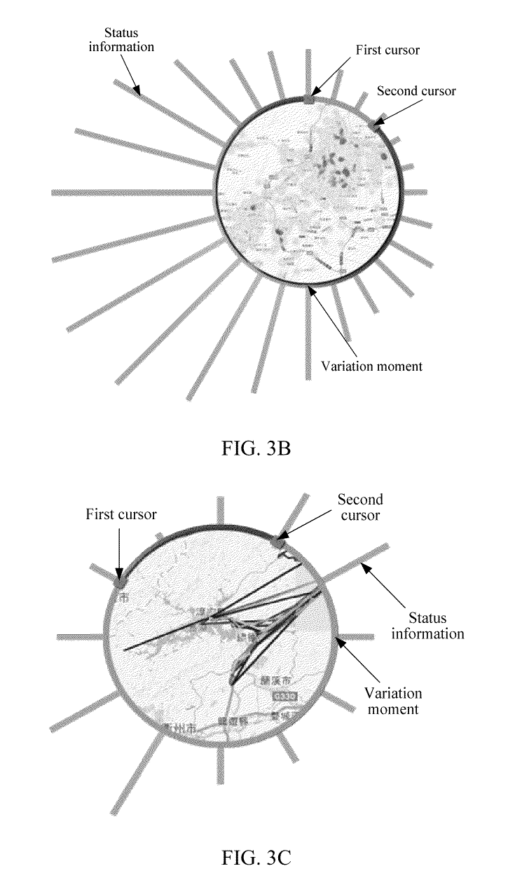

An embodiment of the present disclosure further provides an apparatus for presenting spatial-temporal data, and a schematic structural diagram of the apparatus for presenting spatial-temporal data is shown in FIG. 4, including a query request unit 10 configured to receive a user query request. The user query request includes a spatial condition, and may further include information about features that need to be queried and that are of a region corresponding to the spatial condition. In addition a user query request may further include information that is input by a user and that is about a time period that needs to be queried, that is, a time condition or the like. A data acquiring unit 11 configured to acquire spatial-temporal data that the user query request requests to query and that is received by the query request unit 10, where the spatial-temporal data includes regional data corresponding to the spatial condition, and variation data of a preset feature of a region corresponding to the spatial condition. The variation data may include variation moments of the feature, status information of the feature at the variation moments, and the like. A presentation unit 12 configured to present a graph of the spatial-temporal data acquired by the data acquiring unit 11, so that the graph presents the regional data and the variation data of the preset feature.

As can be seen, in this embodiment of the present disclosure, when querying data according to a user query request, the data acquiring unit 11 in the apparatus for presenting spatial-temporal data finds various types of data that correspond to a spatial condition and that are included in the data that the user query request requests to query. The various types of data include regional data and variation data of a preset feature, and the presentation unit 12 presents, in a graph, both the regional data and the variation data of the preset feature. In this way, various types of data are found during data query, so that the spatial-temporal data is presented in a centralized way in a specific manner, and spatial-temporal data dynamics may be further presented. Therefore, a user intuitively views an association relationship between spatial data and temporal data, which facilitates further analysis of the data.

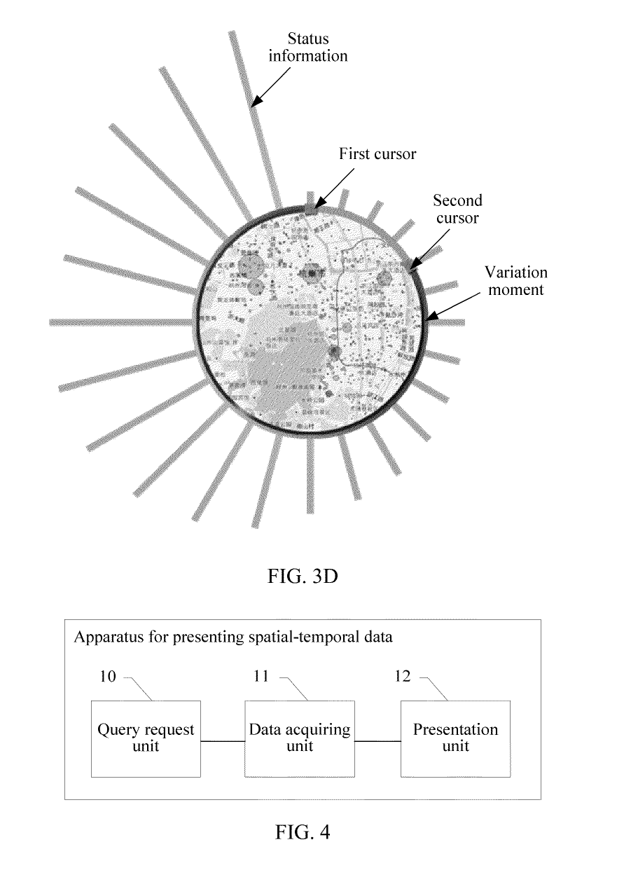

Referring to FIG. 5, in a specific embodiment, the apparatus for presenting spatial-temporal data may include an operation request unit 13, and the presentation unit 12 may further make the graph include a closed boundary. The presentation unit 12 may be implemented using a region presentation subunit 120, a moment presentation subunit 121, and a status presentation subunit 122.

The region presentation subunit 120 is configured to present, inside the boundary, the regional data.

The moment presentation subunit 121 is configured to present, on the boundary, the variation moments in the variation data.

The status presentation subunit 122 is configured to present, outside the boundary at the variation moments, status information of the preset feature of the region corresponding to the spatial condition. The status presentation subunit 122 may be further configured to represent the status information using a linear or column bar extending to the outside from the boundary, where a length of the linear or column bar is used to indicate a weighted value of status information of the preset feature of locations in the region that corresponds to the spatial condition, or a calculated value of the weighted value.

The operation request unit 13 is configured to receive, from the graph, an operation request of a user for the first cursor or the second cursor. If it is requested to slide the first cursor or the second cursor to a variation moment, slide the first cursor or the second cursor to the variation moment along the boundary, and present, outside the boundary at the variation moment, corresponding status information.

In this embodiment, after the data acquiring unit 11 acquires the spatial-temporal data, the graph of the spatial-temporal data may be presented to the user using the foregoing region presentation subunit 120, moment presentation subunit 121, and status presentation subunit 122.

In a specific embodiment, the moment presentation subunit 121 may respectively represent, using two sliding cursors (the first cursor and the second cursor) on the boundary, an acquiring start time and an acquiring end time of the spatial-temporal data acquired by the foregoing data acquiring unit 11. In this case, the user may drag the two cursors to view variation information corresponding to variation moments within a time period. In this way, when the operation request unit 13 receives, from the graph, an operation request of the user for the second cursor, a corresponding operation is performed. Further, in this case, the status presentation subunit 122 in the presentation unit 12 may present status information mainly in the following two manners:

(1) The status presentation subunit 122 presents once and for all, in the graph, status information of variation moments within this time period from the acquiring start time to the acquiring end time.

(2) The status presentation subunit 122 sequentially presents, outside the boundary, the corresponding status information at the variation moments, and the moment presentation subunit 121 is further configured to present, on the boundary at a variation moment that corresponds to the acquiring start time of the spatial-temporal data, the first cursor, and sequentially slide the second cursor to the variation moments on the boundary, where the first cursor and the second cursor respectively represent the acquiring start time and the acquiring end time of the spatial-temporal data.

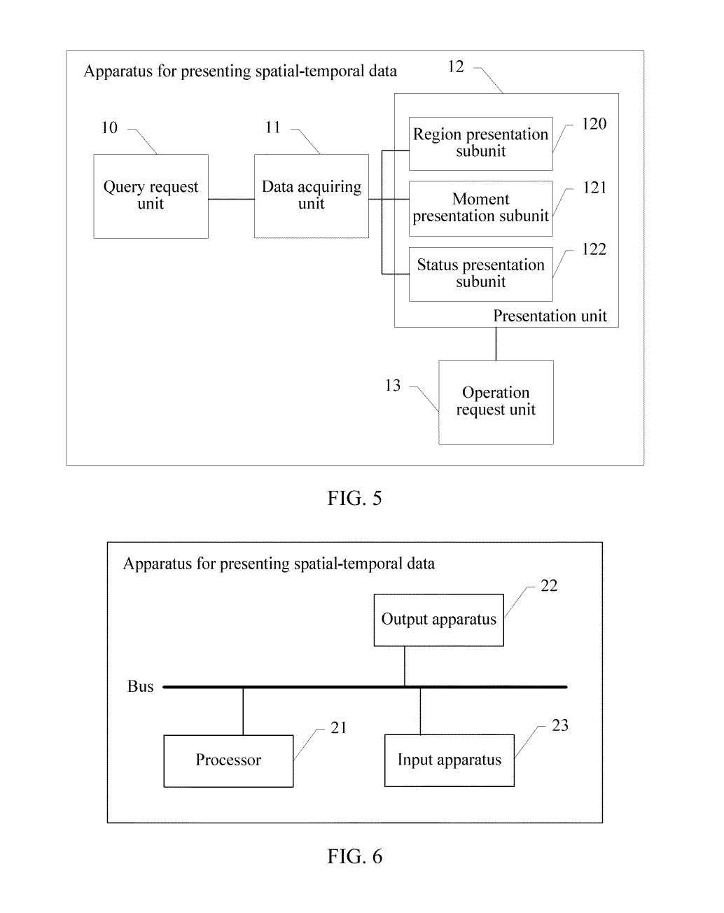

An embodiment of the present disclosure further provides another apparatus for presenting spatial-temporal data, and a schematic structural diagram of the apparatus for presenting spatial-temporal data is shown in FIG. 6, including a processor 21, an output apparatus 22, and an input apparatus 23 that are separately connected to a bus. The apparatus for presenting spatial-temporal data may further include a memory or the like.

The memory is configured to store data input from the input apparatus 23, and may further store information such as a necessary file for processing data. The input apparatus 23 and the output apparatus 22 may include a peripheral of the apparatus for presenting spatial-temporal data, for example, a display, a keyboard, a mouse, and a printer, and may further include a port for communication between the apparatus for presenting spatial-temporal data and another device.

The processor 21 is configured to acquire spatial-temporal data that the user query request requests to query when the input apparatus 23 receives a user query request, where the user query request includes a spatial condition, where the spatial-temporal data includes regional data corresponding to the spatial condition, and variation data of a preset feature of a region corresponding to the spatial condition, and present a graph of the spatial-temporal data acquired by the output apparatus 22, so that the graph presents the regional data and the variation data of the preset feature. The user query request may further include information about features that need to be queried and that are of a region corresponding to the spatial condition, and may further include information that is input by a user and that is about a time period that needs to be queried, that is, a time condition or the like. The foregoing variation data may include variation moments of the preset feature, status information of the feature at the variation moments, and the like. In this way, various types of data are found during data query, so that the spatial-temporal data is presented in a centralized way in a specific manner, and spatial-temporal data dynamics may be further presented. Therefore, a user intuitively views an association relationship between spatial data and temporal data, which facilitates further analysis of the data.

In a specific embodiment, after the processor 21 in the apparatus for presenting spatial-temporal data acquires the spatial-temporal data, when the output apparatus 22 presents the graph of the spatial-temporal apparatus, the graph includes a closed boundary. Furthermore, the regional data may be presented inside the boundary, the variation moments in the variation data are presented on the boundary, status information of the preset feature of the region that corresponds to the spatial condition is presented outside the boundary at the variation moment, where the status information herein may be represented using a linear or column bar extending to the outside from the boundary, and a length of the linear or column bar is used to indicate a weighted value of status information of the preset feature of locations in the region that corresponds to the spatial condition, or a calculated value of the weighted value.

In another specific embodiment, the processor 21 may respectively represent, using the output apparatus 22 using two sliding cursors (a first cursor and a second cursor) on the boundary, an acquiring start time and an acquiring end time of the foregoing spatial-temporal data. In this case, the user may drag the two cursors to view variation information corresponding to variation moments within a time period. In this way, when the input apparatus 23 receives, from the graph, an operation request of the user for the first cursor or the second cursor, if it is requested to slide the first cursor or the second cursor to a variation moment, the processor 21 is further configured to slide the first cursor or the second cursor to the variation moment along the boundary, and present, outside the boundary at the variation moment, corresponding status information. Further, in this case, the processor 21 may present status information by means of the output apparatus 22 mainly in the following two manners:

(1) Status information of variation moments within this time period from the acquiring start time to the acquiring end time is presented once and for all in the graph.

(2) The corresponding status information at the variation moments are sequentially presented outside the boundary, and the first cursor is presented on the boundary at a variation moment that corresponds to the acquiring start time of the spatial-temporal data, and the second cursor sequentially slides to the variation moments on the boundary, where the first cursor and the second cursor respectively represent the acquiring start time and the acquiring end time of the spatial-temporal data.

A person of ordinary skill in the art may understand that all or a part of the steps of the methods in the embodiments may be implemented by a program instructing relevant hardware. The program may be stored in a computer readable storage medium. The storage medium may include a read-only memory (ROM), a random access memory (RAM), a magnetic disk, or an optical disc.

The spatial-temporal data display method and apparatus provided in the embodiments of the present disclosure are described in detail above. The principle and implementation of the present disclosure are described herein through specific examples. The description about the embodiments of the present disclosure is merely provided to help understand the method and core ideas of the present disclosure. In addition, a person of ordinary skill in the art can make variations and modifications to the present disclosure in terms of the specific implementations and application scopes according to the ideas of the present disclosure. Therefore, the content of specification shall not be construed as a limit to the present disclosure.

What is claimed is:

1. A method for presenting spatial-temporal data, comprising:
receiving a user query request, wherein the user query request comprises a spatial condition;
acquiring spatial-temporal data that the user query request requests to query, wherein the spatial-temporal data comprises regional data corresponding to the spatial condition, and variation data of a preset feature of a region corresponding to the spatial condition; and
presenting a graph of the acquired spatial-temporal data, such that the graph presents the regional data and the variation data of the preset feature.

2. The method according to claim 1, wherein the graph comprises a closed boundary, wherein the variation data comprises variation moments and status information of the preset feature at the variation moments, and wherein presenting the graph of the acquired spatial-temporal data comprises:
presenting, inside the boundary, the regional data;
presenting, on the boundary, the variation moments in the variation data; and
presenting, outside the boundary at the variation moments, status information of the preset feature of the region corresponding to the spatial condition.

3. The method according to claim 2, wherein presenting, outside the boundary at the variation moments, the status information of the preset feature of the region corresponding to the spatial condition comprises representing the status information using a linear or column bar extending to the outside from the boundary, wherein a length of the linear or column bar is used to indicate a weighted value of status information of the preset feature of locations in the region that corresponds to the spatial condition or a calculated value of the weighted value.

4. The method according to claim 2, wherein presenting, outside the boundary at the variation moments, the status information of the preset feature of the region corresponding to the spatial condition comprises sequentially presenting, outside the boundary, the corresponding status information at the variation moments, wherein presenting, on the boundary, the variation moments in the variation data comprises presenting, on the boundary at a variation moment corresponding to an acquiring start time of the spatial-temporal data, a first cursor, and sequentially sliding a second cursor to the variation moments on the boundary, and wherein the first cursor and the second cursor respectively represent the acquiring start time and an acquiring end time of the spatial-temporal data.

5. The method according to claim 4, further comprising:
receiving, from the graph, an operation request of a user for the first cursor or the second cursor;
sliding the first cursor or the second cursor to a variation moment along the boundary when it is requested to slide the first cursor or the second cursor to the variation moment; and
presenting, outside the boundary at the variation moment, corresponding status information.

6. An apparatus for presenting spatial-temporal data, comprising:
a query request unit configured to receive a user query request, wherein the user query request comprises a spatial condition;
a data acquiring unit configured to acquire spatial-temporal data that the user query request requests to query and that is received by the query request unit, wherein the spatial-temporal data comprises regional data corresponding to the spatial condition, and variation data of a preset feature of a region corresponding to the spatial condition; and
a presentation unit configured to present a graph of the spatial-temporal data acquired by the data acquiring unit, such that the graph presents the regional data and the variation data of the preset feature.

7. The apparatus according to claim 6, wherein the graph comprises a closed boundary, and the presentation unit comprises:
a region presentation subunit configured to present, inside the boundary, the regional data;
a moment presentation subunit configured to present, on the boundary, the variation moments in the variation data; and
a status presentation subunit configured to present, outside the boundary at the variation moments, status information of the preset feature of the region corresponding to the spatial condition.

8. The apparatus according to claim 7, wherein the status presentation subunit is configured to represent the status information by using a linear or column bar extending to the outside from the boundary, and wherein a length of the linear or column bar is used to indicate a weighted value of status information of the preset feature of locations in the region that corresponds to the spatial condition, or a calculated value of the weighted value.

9. The apparatus according to claim 7, wherein the status presentation subunit is further configured to sequentially present, outside the boundary, the corresponding status information at the variation moments, wherein the moment presentation subunit is further configured to present, on the boundary at a variation moment corresponding to an acquiring start time of the spatial-temporal data, a first cursor, and sequentially slide a second cursor to the variation moments on the boundary, and wherein the first cursor and the second cursor respectively represent the acquiring start time and an acquiring end time of the spatial-temporal data.

10. The apparatus according to claim 9, further comprising an operation request unit configured to:
receive, from the graph, an operation request of a user for the first cursor or the second cursor;
slide the first cursor or the second cursor to the variation moment along the boundary when it is requested to slide the first cursor or the second cursor to a variation moment; and
present, outside the boundary at the variation moment, corresponding status information.
